(19) United States
(12) Patent Application Publication
(10) Pub. No.: US 2026/0176479 A1
(43) Pub. Date: Jun. 25, 2026

(54) A METALLIC EFFECT COATING COMPOSITION AND ITS APPLICATIONS THEREOF

(71) Applicant: BASF COATINGS GMBH, Muenster (DE)

(72) Inventors: Guo Sheng YANG, Shanghai (CN); Na DING, Shanghai (CN); Wei SONG, Shanghai (CN); An Hua GU, Shanghai (CN)

(21) Appl. No.: 19/132,411

(22) PCT Filed: Nov. 22, 2023
(86) PCT No.: PCT/EP2023/082645

§ 371 Date: May 23, 2025

(30) Foreign Application Priority Data
Dec. 5, 2022 (WO) PCT/CN2022/136601

(51) Int. Cl. C09D 5/36; C09D 7/41; C09D 7/61; C09D 175/04

(52) U.S. Cl. CPC C09D 5/36; C09D 7/41; C09D 7/61; C09D 175/04

(57) ABSTRACT

Disclosed herein is a coating composition including (A) a pigment composition including: (A-1) a yellowish red pigment; (A-2) a magenta pigment; and (A-3) a greenish blue pigment, (B) a binder; (C) carbon black; and (D) aluminum, where the sum of weight percentages of components (A-1), (A-2) and (A-3) is at least 80% by weight based on the total weight of component (A), offering a distinctive grey color travel. Also disclosed herein are a coating film with the distinctive grey color travel and applications of the coating composition.

### TECHNICAL FIELD

The present invention relates to a coating composition and more specifically relates to a metallic effect coating composition used for automtives capable of forming a coating film having color-travel properties.

### BACKGROUND

Coating compositions which are capable of forming coating films having color-travel properties (also named color-travel coating compositions) are known and are widely used in various applications. For example, in the automotive field, color-travel coating compositions are applied mostly for high-end customization of luxury brands cars, enabling the cars to have a distinctive color. The color-travel property of the formed color-travel coating films is generated from a specific kind of pigment compositions contained in color-travel coating compositions, which is called color-travel pigment composition.

Traditionally, color-travel pigment compositions (such as those applicable for a car) are made of a kind of pigments with a special optical effect, which is developed based on strict control of the particle size of pigment particles and the diameter-thickness ratio of the substrates that used, precise control of coating thickness through multiple layers, and use of multiple metal oxides, to achieve desired color strength and color-travel property. However, there are several defects of these color-travel pigment compositions due to the use of such optical effect pigments, mainly because: 1) the hiding power of the optical effect pigments is not good, the thickness uniformity of the formed coating layer will affect the color of the finished product; 2) a variety of factors will affect the orientation of the optical effect pigment particles during the spraying application, which will lead to color deviation; 3) the control of the optical effect is difficult and complicated; and 4) the color-travel pigment compositions made from optical effect pigment have high sedimentation possibility. Because of these defects, there are generally issues in terms of color quality and color stability. For example, there may be color differences from batch to batch of the pigment compositions, and when a color-travel coated product (such as a color-travel coated car) is damaged, for example is cut or scratched, it can hardly be repaired to obtain the original appearance.

Therefore, it is required to provide a new type of coating compositions capable of forming a coating film having a color-travel property, which comprises a color-travel pigment composition, wherein the coating films of the coating compositions have a distinctive color, and have greatly improved color quality and batch-to-batch color stability, as compared with those formed from using optical effect pigments.

### SUMMARY OF THE INVENTION

In one aspect, the present invention provides a metallic effect coating composition comprising
(A) a pigment composition comprising:
   (A-1) a yellowish red pigment;
   (A-2) a magenta pigment; and
   (A-3) a greenish blue pigment,
(B) a binder;
(C) carbon black, preferably gas black; and
(D) aluminum, wherein the sum of weight perctanges of components (A-1), (A-2) and (A-3) is at least 80%, preferably at least 95% and more prferably 100% by weight based on the total weight of compoent (A).

In another aspect, the present invention provides a coating film obtained from the invented coating composition having CIELAB color space with L*, a*, b* values as defined in at least three of conditions I, II, III, IV and V, preferably at least four of conditions I, II, III, IV and V, and more preferably all of conditions I, II, III, IV and V:

| | Observing | | | |
|---|---|---|---|---|
| Condition | angle | L* | a* | b* |
| I | 15° | from 47 to 67, | from −11 to 5, | from −13 to 7, |
| | | preferably | preferably | preferably |
| | | from 54 to 62 | from −11 to −2 | from −13 to −5 |
| II | 25° | from 30 to 50, | from −8 to 2, | from −11 to 5, |
| | | preferably | preferably | preferably |
| | | from 39 to 45 | from −8 to −1 | from −10 to −5 |
| III | 45° | from 12 to 32, | from −3 to 3, | from −7 to 1, |
| | | preferably | preferably | preferably |
| | | from 18 to 28 | from −2 to 0 | from −6 to −2 |
| IV | 75° | from 4 to 24, | from 2 to 8, | from −2 to 4, |
| | | preferably | preferably | preferably |
| | | from 8 to 18 | from 3 to 6 | from −1 to 3 |
| V | 110° | from 0 to 20, | from 3 to 9, | from −1 to 5, |
| | | preferably 5 | preferably | preferably |
| | | to 12 | from 3 to 8 | from 0 to 4 |

In another aspect, the present invention provides a coating film obtained from the invented coating composition having CIEHLC color space with C*, h° values as defined in at least three of conditions VI, VII, VIII, IX and X, preferably at least four of conditions VI, VII, VIII, IX and X, and more preferably all of conditions VI, VII, VIII, IX and X:

| | Observing | | |
|---|---|---|---|
| Condition | angle | C* | h° |
| VI | 15° | from 9 to 15, | from 210 to 250, preferably |
| | | preferably | from 215 to 240 |
| | | from 9 to 14 | |
| VII | 25° | from 6 to 12, | from 220 to 260, preferably |
| | | preferably | from 225 to 250 |
| | | from 7 to 10 | |
| VIII | 45° | from 1 to 7, | from 250 to 290, preferably |
| | | preferably | from 250 to 285 |
| | | from 3 to 5 | |
| IX | 75° | from 2 to 8, | 0 to 20, preferably 0 to 18 |
| | | preferably | or 350 to 360, preferably 355 |
| | | from 2 to 6 | to 360 |
| X | 110° | from 3 to 9, | from 8 to 30, preferably from 9 |
| | | preferably | to 30 |
| | | from 4 to 8 | |

In a further aspect, the present invention provides applications of the invented coating composition in the fields of architecture, industry, automotives, household appliance, leathers, inks, textiles and papers etc.

The coating film obtained from the invented coating composition has a distinctive grey color travel of from blue-grey-red hue with observing angle being changed. The invented coating composition achieves the required color-travel property without optical effect pigment and therefore disadvantages such as poor color quality and color fluctuations by batch could be avoided.

### DETAILED DESCRIPTION OF THE INVENTION

The present invention now will be described more fully hereinafter, in which some, but not all embodiments of the invention are shown. Indeed, this invention can be embodied in many different forms and should not be construed as limited to the embodiments set forth herein; rather, these embodiments are provided so that this disclosure will satisfy applicable legal requirements.

In the context of the present disclosure, expressions “a”, “an”, “the”, when used to define a term, include both the plural and singular forms of the term.

In the context of the present disclosure, the terms “comprise”, “comprising”, etc. are used interchangeably with “contain”, “containing”, etc, and are to be interpreted in a non-limiting, open manner. That is, e.g., further components or elements may be present. The expressions “consists of” or “consists essentially of” or cognates, if used, may be embraced within “comprises” or cognates.

In the context of the present disclosure, for convenience, “resin” is used in this disclosure to encompass resin, oligomer, and polymer. “Binder” refers to the film-forming components of the coating composition. Thus, resins, crosslinkers, and other film-formers are part of the binder, but solvents, pigments, additives like antioxidants, light stabilizer (such as hindered amine light stabilizer, HALS), UV absorbers, and the like are not part of the binder.

In the context of the present disclosure, “CIELAB color space”, also referred to as L*a*b*, is a color space defined by the International Commission on Illumination (abbreviated CIE) in 1976. It expresses color as three values: L* for perceptual lightness; a* and b* for the four unique colors of human vision: red, green, blue and yellow.

In the content of the present disclosure, “CIEHLC color space” is a color space based on CIELAB, which uses the polar coordinates C* (chroma, relative saturation) and h° (hue angle, angle of the hue in the CIELAB color wheel) instead of the Cartesian coordinates a* and b*. The CIELAB lightness L* remains unchanged. The conversion of a* and b* to C* and h° is performed as follows: C*=(a*²+b*²)^{1/2}; h°=atan (b*/a*).

### Coating Composition

The present invention provides a metallic effect coating composition comprising
(A) a pigment composition comprising:
   (A-1) a yellowish red pigment;
   (A-2) a magenta pigment; and
   (A-3) a greenish blue pigment,
(B) a binder;
(C) carbon black, preferably gas black; and
(D) aluminum, wherein the sum of weight percentages of components (A-1), (A-2) and (A-3) is at least 80%, preferably at least 95% and more preferably 100% by weight based on the total weight of component (A).

The invented coating composition is capable of forming a coating film having CIELAB color space with L*, a*, b* values as defined in at least three of conditions I, II, III, IV and V, preferably, at least four of conditions I, II, III, IV and V and more preferably all of conditions I, II, III, IV and V:

| | Observing | | | |
|---|---|---|---|---|
| Condition | angle | L* | a* | b* |
| I | 15° | from 47 to 67, | from −11 to 5, | from −13 to 7, |
| | | preferably | preferably | preferably |
| | | from 54 to 62 | from −11 to −2 | from −13 to −5 |
| II | 25° | from 30 to 50, | from −8 to 2, | from −11 to 5, |
| | | preferably | preferably | preferably |
| | | from 39 to 45 | from −8 to −1 | from −10 to −5 |
| III | 45° | from 12 to 32, | from −3 to 3, | from −7 to 1, |
| | | preferably | preferably | from preferably |
| | | from 18 to 28 | from −2 to 0 | −6 to −2 |
| IV | 75° | from 4 to 24, | from 2 to 8, | from −2 to 4, |
| | | preferably | preferably | preferably |
| | | from 8 to 18 | from 3 to 6 | from −1 to 3 |
| V | 110° | from 0 to 20, | from 3 to 9, | from −1 to 5, |
| | | preferably | preferably | preferably |
| | | from 5 to 12 | from 3 to 8 | from 0 to 4 |

The invented coating composition is capable of forming a coating film having CIEHLC color space with C* and h° values as defined in at least three condition of VI, VII, VIII, IX and X, preferably at least four of conditions VI, VII, VIII, IX and X, and more preferably all of conditions VI, VII, VIII, IX and X:

| | Observing | | |
|---|---|---|---|
| Condition | angle | C* | h° |
| VI | 15° | from 9 to 15, | from 210 to 250, |
| | | preferably | preferably |
| | | from 9 to 14 | from 215 to 240 |
| VII | 25° | from 6 to 12, | from 220 to 260, |
| | | preferably | preferably |
| | | from 7 to 10 | from 225 to 250 |
| VIII | 45° | from 1 to 7, | from 250 to 290, |
| | | preferably | preferably |
| | | from 3 to 5 | from 250 to 285 |
| IX | 75° | from 2 to 8, | from 0 to 20, |
| | | preferably | preferably |
| | | from 2 to 6 | from 0 to 18; |
| | | | or from 350 to |
| | | | 360, , prefearbly |
| | | | from 355 to 360 |
| X | 110° | from 3 to 9, | from 8 to 30, |
| | | preferably | preferably |
| | | from 4 to 8 | from 9 to 30 |

In an embodiment, the coating film has the CIELAB color space with L*, a*, b* values as defined in three of conditions I, II, III, IV and V, such as conditions I, II and III, or conditions I, II and IV, or conditions I, II and IV, or conditions I, III and IV, or conditions I, III and V, or conditions II, III and IV, or conditions II, III and V, or conditions III, IV and V, preferably conditions I, III and IV.

In an embodiment, the coating film has the CIELAB color space with L*, a*, b* values as defined in four of conditions I, II, III, IV and V, such as conditions I, II, III and IV, or conditions I, II, III and V, or conditions I, III, IV and V, or conditions II, III, IV and V.

In an embodiment, the coating film has the CIELAB color space with L*, a*, b* values as defined in all of conditions I, II, III, IV and V.

In an embodiment, the coating film has the CIEHLC color space with C*, h° values as defined in three of conditions VI, VII, VIII, IX and X, such as conditions VI, VII and VIII, or conditions VI, VII and IX, or conditions VI, VII and IX, or conditions VI, VIII and IX, or conditions VI, VIII and X, or conditions VII, VIII and IX, or conditions VII, VIII and X, or conditions VIII, IX and X, preferably conditions VI, VIII and IX.

In an embodiment, the coating film has the CIEHLC color space with C*, h° values as defined in four of conditions VI, VII, VIII, IX and X, such as conditions VI, VII, VIII and IX, or conditions VI, VII, VIII and X, or conditions VI, VIII, IX and X, or conditions VII, VIII, IX and X.

In an embodiment, the coating film has the CIEHLC color space with C*, h° values as defined in all of conditions VI, VII, VIII, IX and X.

### Pigment Composition

The pigment composition in the coating composition of the present invention comprises:
(A-1) yellowish red pigment;
(A-2) magenta pigment; and
(A-3) greenish blue pigment.

The term “pigment” is well known in the art, which refers to a kind of materials that is applicable for coloring a substrate and is insoluble in a solvent and water. The particle size of the pigment can be determined by a skilled person according to practical applications. Preferably, the pigment may have a primary particle size in a range of 0.01 μm to 1 μm, more preferably in a range of from 0.3 μm to 1 μm.

Preferably, based on the weight of the pigment composition of the present invention, the amount of component (A-1) is in a range of 20 to 60% by weight or 30 to 60% by weight or 20 to 50% by weight or 30 to 50% by weight, preferably in range of 40 to 60% by weight. For the purpose of the present invention, component (A-1) is selected from C.I. Pigment Red 101, or C.I. Pigment Red 254.

Preferably, based on the weight of the pigment composition of the present invention, the amount of component (A-2) is in a range of 10 to 40% by weight or 10 to 30% by weight or 20 to 40% by weight or 15 to 40% by weight, preferably in a range of 10 to 20% by weight. For the purpose of the present invention, component (A-2) is selected from C.I. Pigment Red 122, C.I. Pigment Red 202, C.I. Pigment Violet 19, or a combination of C.I. Pigment Red 177 and C.I. Pigment Violet 23, preferably with a combination ratio of from 10:1 to 1:10, more preferably from 10:1 to 1:2.

Preferably, based on the weight of the pigment composition of the present invention, the amount of component (A-3) is in a range of 20 to 50% by weight or 25 to 50% by weight or 30 to 50% by weight or 25 to 40% by weight, preferably in a range of 20 to 40% by weight. For the purpose of the present invention, component (A-3) is selected from C.I. Pigment Blue 15; a combination of C.I. Pigment Blue 15 and C.I. Pigment Green 7, preferably with a combination ratio of from 2:1 to 1:2, more preferably from 1.2:1 to 1:1.2; or a combination of C.I. Pigment Blue 15 and C.I. Pigment Green 36, preferably with a combination ratio of from 25:1 to 1:1, more preferably from 20:1 to 1:1, preferably component (A-3) is selected from a combination of C.I. Pigment Blue 15 and C.I. Pigment Green 7 or a combination of C.I. Pigment Blue 15 and C.I. Pigment Green 36.

Preferably, component (A-1), (A-2) and (A-3) comprise at least 80% by weight, more preferably at least 90% by weight, still more preferably at least 95% by weight of the pigment composition of the present invention. Most preferably, component (A-1), (A-2) and (A-3) comprise 100% by weight of the pigment composition of the present invention.

In an embodiment of the invention, the pigment composition of the present invention is pigment composition (1), wherein:
component (A-1) is C.I. Pigment Red 101,
component (A-2) is C.I. Pigment Red 122, and
component (A-3) is a combination of C.I. Pigment Blue 15 and C.I. Pigment Green 7.

In an embodiment of the invention, the pigment composition of the present invention is pigment composition (2), wherein:
component (A-1) is C.I. Pigment Red 101,
component (A-2) is C.I. Pigment Red 122, and
component (A-3) is a combination of C.I. Pigment Blue 15 and C.I. Pigment Green 36.

In an embodiment of the invention, the pigment composition of the present invention is pigment composition (3), wherein:
component (A-1) is C.I. Pigment Red 101,
component (A-2) is C.I. Pigment Red 122, and
component (A-3) is C.I. Pigment Blue 15.

In an embodiment of the invention, the pigment composition of the present invention is pigment composition (4), wherein:
component (A-1) is C.I. Pigment Red 101,
component (A-2) is C.I. Pigment Red 202, and
component (A-3) is a combination of C.I. Pigment Blue 15 and C.I. Pigment Green 7.

In an embodiment of the invention, the pigment composition of the present invention is pigment composition (5), wherein:
component (A-1) is C.I. Pigment Red 101,
component (A-2) is C.I. Pigment Red 202, and
component (A-3) is a combination of C.I. Pigment Blue 15 and C.I. Pigment Green 36.

In an embodiment of the invention, the pigment composition of the present invention is pigment composition (6), wherein:
component (A-1) is C.I. Pigment Red 101,
component (A-2) is C.I. Pigment Red 202, and
component (A-3) is C.I. Pigment Blue 15.

In an embodiment of the invention, the pigment composition of the present invention is pigment composition (7), wherein:
component (A-1) is C.I. Pigment Red 101,
component (A-2) is C.I. Pigment Violet 19, and
component (A-3) is a combination of C.I. Pigment Blue 15 and C.I. Pigment Green 7.

In an embodiment of the invention, the pigment composition of the present invention is pigment composition (8), wherein:
component (A-1) is C.I. Pigment Red 101,
component (A-2) is C.I. Pigment Violet 19, and
component (A-3) is a combination of C.I. Pigment Blue 15 and C.I. Pigment Green 36.

In an embodiment of the invention, the pigment composition of the present invention is pigment composition (9), wherein:
component (A-1) is C.I. Pigment Red 101,
component (A-2) is C.I. Pigment Violet 19, and
component (A-3) is C.I. Pigment Blue 15.

In an embodiment of the invention, the pigment composition of the present invention is pigment composition (10), wherein:
component (A-1) is C.I. Pigment Red 101,
component (A-2) is a combination of C.I. Pigment Red 177 and C.I. Pigment Violet 23, and
component (A-3) is a combination of C.I. Pigment Blue 15 and C.I. Pigment Green 7.

In an embodiment of the invention, the pigment composition of the present invention is pigment composition (11), wherein:
component (A-1) is C.I. Pigment Red 101,
component (A-2) is a combination of C.I. Pigment Red 177 and C.I. Pigment Violet 23, and
component (A-3) is a combination of C.I. Pigment Blue 15 and C.I. Pigment Green 36.

In an embodiment of the invention, the pigment composition of the present invention is pigment composition (12), wherein:
component (A-1) is C.I. Pigment Red 101,
component (A-2) is a combination of C.I. Pigment Red 177 and C.I. Pigment Violet 23, and
component (A-3) is C.I. Pigment Blue 15.

In an embodiment of the invention, the pigment composition of the present invention is pigment composition (13), wherein:
component (A-1) is C.I. Pigment Red 254,
component (A-2) is C.I. Pigment Red 122, and
component (A-3) is a combination of C.I. Pigment Blue 15 and C.I. Pigment Green 7.

In an embodiment of the invention, the pigment composition of the present invention is pigment composition (14), wherein:
component (A-1) is C.I. Pigment Red 254,
component (A-2) is C.I. Pigment Red 122, and
component (A-3) is a combination of C.I. Pigment Blue 15 and C.I. Pigment Green 36.

In an embodiment of the invention, the pigment composition of the present invention is pigment composition (15), wherein:
component (A-1) is C.I. Pigment Red 254,
component (A-2) is C.I. Pigment Red 122, and
component (A-3) is C.I. Pigment Blue 15.

In an embodiment of the invention, the pigment composition of the present invention is pigment composition (16), wherein:
component (A-1) is C.I. Pigment Red 254,
component (A-2) is C.I. Pigment Red 202, and
component (A-3) is a combination of C.I. Pigment Blue 15 and C.I. Pigment Green 7.

In an embodiment of the invention, the pigment composition of the present invention is pigment composition (17), wherein:
component (A-1) is C.I. Pigment Red 254,
component (A-2) is C.I. Pigment Red 202, and
component (A-3) is a combination of C.I. Pigment Blue 15 and C.I. Pigment Green 36.

In an embodiment of the invention, the pigment composition of the present invention is pigment composition (18), wherein:
component (A-1) is C.I. Pigment Red 254,
component (A-2) is C.I. Pigment Red 202, and
component (A-3) is C.I. Pigment Blue 15.

In an embodiment of the invention, the pigment composition of the present invention is pigment composition (19), wherein:
component (A-1) is C.I. Pigment Red 254,
component (A-2) is C.I. Pigment Violet 19, and
component (A-3) is a combination of C.I. Pigment Blue 15 and C.I. Pigment Green 7.

In an embodiment of the invention, the pigment composition of the present invention is pigment composition (20), wherein:
component (A-1) is C.I. Pigment Red 254,
component (A-2) is C.I. Pigment Violet 19, and
component (A-3) is a combination of C.I. Pigment Blue 15 and C.I. Pigment Green 36.

In an embodiment of the invention, the pigment composition of the present invention is pigment composition (21), wherein:
component (A-1) is C.I. Pigment Red 254,
component (A-2) is C.I. Pigment Violet 19, and
component (A-3) is C.I. Pigment Blue 15.

In an embodiment of the invention, the pigment composition of the present invention is pigment composition (22), wherein:
component (A-1) is C.I. Pigment Red 254,
component (A-2) is a combination of C.I. Pigment Red 177 and C.I. Pigment Violet 23, and
component (A-3) is a combination of C.I. Pigment Blue 15 and C.I. Pigment Green 7.

In an embodiment of the invention, the pigment composition of the present invention is pigment composition (23), wherein:
component (A-1) is C.I. Pigment Red 254,
component (A-2) is a combination of C.I. Pigment Red 177 and C.I. Pigment Violet 23, and
component (A-3) is a combination of C.I. Pigment Blue 15 and C.I. Pigment Green 36.

In an embodiment of the invention, the pigment composition of the present invention is pigment composition (24), wherein:
component (A-1) is C.I. Pigment Red 254,
component (A-2) is a combination of C.I. Pigment Red 177 and C.I. Pigment Violet 23, and
component (A-3) is C.I. Pigment Blue 15.

In an embodiment of the invention, the pigment composition of the present invention is any combination of two or more compositions selected from pigment composition (1) to composition (24).

According to the present invention, coating composition can contain no optical effect pigments. Typically, effect pigments are a laminar platy substrate such as natural mica or glass flake that has been coated with a metal oxide layer. A description of effect pigments' properties can be found in the Pigment Handbook, Volume I, Second Edition, pp. 829-858, John Wiley & Sons, NY 1988.

The pigment composition of the present invention can be prepared by a skilled person using a process known in the art.

Preferably, as component (i), the amount of the pigment composition in the coating composition of the present invention is in a range of 0.3 to 3% by weight (for example 0.3, 0.5, 1, 1.5, 2, 2.5 or 3% by weight), preferably in a range of 0.5 to 2% by weight, based on the weight of the coating composition.

### Binder

The coating composition of the present invention comprises a binder as component (ii).

The binder may be any that is suitable for coating compositions. For example, the binder may be selected from a group consisting of polyester resin, polyurethane resin, acrylics resin, cellulose acetate butyrate resin, and melamine resin. The binder may be thermosettable, including those resins that are self-crosslinking, curable with a curing or crosslinking agent, or curable by exposure to actinic radiation such as UV or EB radiation, and crosslinking agents for such resins. The binder may include any one or combination of a wide variety of resins or polymers. Nonlimiting examples of suitable curable polymers include vinyl polymers such as acrylic polymers (poly(meth)acrylates) and modified acrylic polymers including those that are branched, grafted, and copolymers having polyester, polyether, or other blocks, polyesters, polyurethanes, polyurethanes prepared using macomonomers such as polyester diols, polyether diols, and polycarbonate diols; alkyds, epoxy resins, polycarbonates, polyamides, polyimides, polysiloxanes, alkyds, and unsaturated oligomers and resins, and mixtures thereof, all of which are known in the art. In various embodiments, the curable polymer has groups reactive with a crosslinker. Nonlimiting examples of polymer functional groups include carboxyl, hydroxyl, silanol group, aminoplast functional groups, urea, carbamate, isocyanate (blocked or unblocked), epoxy, cyclic carbonate, amine, aldehyde groups, thiol groups, hydrazide groups, activated methylene groups, and any combinations thereof that may be made in a thermosettable polymer. In various embodiments the polymer functional groups are hydroxyl, primary carbamate, isocyanate, aminoplast functional groups, epoxy, carboxyl and mixtures thereof. In certain embodiments the polymer functional groups are hydroxyl, carboxyl, silanol group, epoxy, and mixtures thereof.

In one embodiment of the invention, the polymer is an acrylic polymer. The acrylic polymer preferably has a number average molecular weight of 500 to 20,000 and more preferably of 1500 to 10,000. The number average molecular weight is determined by gel permeation chromatography of a sample dissolved in tetrahydrofuran using polystyrene or poly(methyl methacrylate) standards. Such polymers are well-known in the art, and can be prepared from monomers such as methyl acrylate, methyl methacrylate, acrylic acid, methacrylic acid, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, ethylhexyl acrylate, ethylhexyl methacrylate, 3,3,5-trimethylhexyl acrylate, 3,3,5-trimethylhexyl methacrylate, stearyl acrylate, stearyl methacrylate, lauryl acrylate or lauryl methacrylate, cycloalkyl acrylates and/or cycloalkyl methacrylates, such as cyclopentyl acrylate, cyclopentyl methacrylate, isobornyl acrylate, isobornyl methacrylate, cyclohexyl acrylate and cyclohexyl methacrylate and vinylaromatic hydrocarbons, such as vinyltoluene, alpha-methylstyrene and styrene, as well as amides or nitriles of acrylic or methacrylic acid, vinyl esters and vinyl ethers. Any crosslinkable functional group, e.g., hydroxyl, amine, glycidyl, carbamate, and so on can be incorporated into the ester portion of the acrylic monomer. Nonlimiting examples of hydroxy-functional acrylic monomers that can be used to form such polymers include hydroxyethyl acrylate, hydroxybutyl acrylate, hydroxybutyl methacrylate, hydroxypropyl acrylate. Amino-functional acrylic monomers would include t-butylaminoethyl methacrylate and t-butylamino-ethylacrylate. Glycidyl groups may be incorporated by copolymerizing glycidyl methacrylate or allyl glycidyl ether, for example. Other acrylic monomers having crosslinkable functional groups in the ester portion of the monomer are also within the skill of the art.

Modified acrylics can also be used as the film-forming curable polymer in the coating compositions. Such acrylics may be polyester-modified acrylics or polyurethane-modified acrylics, as is well known in the art. Polyester-modified acrylics modified with e-caprolactone are described in U.S. Pat. No. 4,546,046 of Etzell et al, the disclosure of which is incorporated herein by reference. Polyurethane-modified acrylics are also well known in the art. They are described, for example, in U.S. Pat. No. 4,584,354, the disclosure of which is incorporated herein by reference.

Polyesters can also be used as a binder resin in the coating composition. Polyester resins may be formulated as acid-functional or hydroxyl-functional resins. The polyester may have an acid number of from 20 to 100, or from 20 to 80, or from 20 to 40 mg KOH per gram. In another embodiment, the polyester may have a hydroxyl number of from 25 to 300, or from 25 to 150, or from 40 to 100 mg KOH per gram. The methods of making polyester resins are well-known. Typically, a polyol component and an acid and/or anhydride component or polymerizable derivative such as a methyl ester are heated together, optionally with a catalyst, and usually with removal of the by-product water or methanol in order to drive the reaction to completion. The polyol component has an average functionality of at least two. The polyol component may contain mono-functional, di-functional, tri-functional, and higher functional alcohols. Diols are preferred, but when some branching of the polyester is desired, higher functionality alcohols are included. Illustrative examples include, without limitation, alkylene glycols and polyalkylene glycols such as ethylene glycol, propylene glycol, diethylene glycol, triethylene glycol, propylene glycol, dipropylene glycol, neopentyl glycol, 1,4-butanediol, 1,3-butanediol, 2,3-butanediol, 1,3-propanediol, 1,5-pentanediol, 1,6-hexanediol, 1,9-nonanediol, 1,4-cyclohexane dimethanol, 2,2,4-trimethyl-1,3-pentanediol, 2-methyl-2-ethyl-1,3-propanediol, 2-ethyl-1,3-hexanediol, hydrogenated bisphenol A, and hydroxyalkylated bisphenols. Optionally, a small amount of tri-functional, and higher functional alcohols may be used, such as glycerine, trimethylolpropane, trimethylolethane, or pentaerythritol. The acid and/or anhydride component comprises compounds having on average at least two carboxylic acid groups and/or anhydrides or low alkyl (C1-C4, particularly methyl) esters of these. Dicarboxylic acids or anhydrides of dicarboxylic acids are preferred, but higher functional acid and anhydrides can be used when some branching of the polyester is desired. Suitable polycarboxylic acid or anhydride compounds include, without limitation, those having from 3 to 20 carbon atoms. Illustrative examples of suitable compounds include, without limitation, phthalic acid, isophthalic acid, terephthalic acid, hexahydrophthalic acid, tetrahydrophthalic acid, pyromellitic acid, malonic acid, maleic acid, succinic acid, azeleic acid, glutaric acid adipic acid, azelaic acid, 1,4-cyclohexanedicarboxylic acid, dodecane-1,12-dicarboxylic acid, citric acid, trimellitic acid, and anhydrides thereof. Optionally, monocarboxylic acids such as octanoic acid, nonanoic acid, stearic acid, and cyclohexanoic acid; and hydroxycarboxylic acids such as dimethylolpropionic acid; as well as combinations of these compounds.

Polyurethanes having crosslinkable functional groups such as hydroxyl groups are also well known in the art. They are prepared by a chain extension reaction of a polyisocyanate (e.g., hexamethylene diisocyanate, isophorone diisocyanate, MDI, and the like) and a polyol (e.g., 1,6-hexanediol, 1,4-butanediol, neopentyl glycol, and any others of those mentioned as useful in preparing a polyester and combinations of these), as well as macrodiols such as polyester diols, polyether diols, and polycarbonate diols. They can be provided with crosslinkable functional groups by capping the polyurethane chain with an excess of diol, polyamine, amino alcohol, or the like.

Carbamate functional polymers and oligomers can also be used as curable polymer, especially those having at least one primary carbamate group.

Carbamate functional examples of the curable polymer used in the coating compositions can be prepared in a variety of ways. For example, and using the case of an acrylic polymer, one way to prepare such polymers is to prepare a monomer, e.g., an acrylic monomer, having carbamate functionality in the ester portion of the monomer. Such monomers are well known in the art and are described, for example in U.S. Pat. Nos. 3,479,328, 3,674,838, 4,126,747, 4,279,833, and 4,340,497, 5,356,669, and WO 94/10211, the disclosures of which are incorporated herein by reference. One method of synthesis involves reaction of a hydroxy ester with urea to form the carbamyloxy carboxylate (i.e., carbamate-modified acrylic). Another method of synthesis reacts an α,β-unsaturated acid ester with a hydroxy carbamate ester to form the carbamyloxy carboxylate. Yet another technique involves formation of a hydroxyalkyl carbamate by reacting a primary or secondary amine or diamine with a cyclic carbonate such as ethylene carbonate. The hydroxyl group on the hydroxyalkyl carbamate is then esterified by reaction with acrylic or methacrylic acid to form the monomer. Other methods of preparing carbamate-modified acrylic monomers are described in the art, and can be utilized as well. The acrylic monomer can then be polymerized along with other ethylenically unsaturated monomers, if desired, by techniques well known in the art.

An alternative route for preparing the curable polymer of the binder is to react an already-formed polymer such as an acrylic polymer, polyester polymer, or polyurethane polymer with another component to form a carbamate-functional group appended to the polymer backbone, as described in U.S. Pat. No. 4,758,632. One technique for preparing such polymers involves thermally decomposing urea (to give off ammonia and HNCO) in the presence of a hydroxy-functional acrylic polymer to form a carbamate-functional polymer. Another technique involves reacting the hydroxyl group of a hydroxyalkyl carbamate with the isocyanate group of an isocyanate-functional polymer to form the carbamate-functional polymer. Isocyanate-functional acrylics are known in the art and are described, for example in U.S. Pat. No. 4,301,257, the disclosure of which is incorporated herein by reference. Isocyanate vinyl monomers are well known in the art and include unsaturated m-tetramethyl xylene isocyanate (sold by American Cyanamid as TMI®). Isocyanate-functional polyurethanes may be formed by using an equivalent excess of diisocyanate or by end-capping a hydroxyl-functional prepolymer with a polyisocyanate. Yet another technique is to react the cyclic carbonate group on a cyclic carbonate-functional acrylic with ammonia in order to form the carbamate-functional acrylic. Cyclic carbonate-functional acrylic polymers are known in the art and are described, for example, in U.S. Pat. No. 2,979,514, the disclosure of which is incorporated herein by reference. Another technique is to transcarbamylate a hydroxy-functional polymer with an alkyl carbamate. A more difficult, but feasible way of preparing the polymer would be to trans-esterify with a hydroxyalkyl carbamate.

The binder of the coating compositions may further comprise a crosslinker. Crosslinkers may be used in amounts of from 10 to 60%, generally from 15 to 55%, or from 25 to 50%, all based on the total binder of the coating composition.

In certain embodiments it may be preferably for the reaction between the crosslinker and polymer to form irreversible linkages. Examples of functional group “pairs” producing thermally irreversible linkages are hydroxy/isocyanate (blocked or unblocked), hydroxy/epoxy, carbamate/aminoplast, carbamate/aldehyde, acid/epoxy, amine/cyclic carbonate, amine/isocyanate (blocked or unblocked), urea/aminoplast, and the like. Nonlimiting examples of crosslinker binder resins include aminoplasts, blocked or unblocked polyisocyanates, polyepoxides, polycarboxylic acid or anhydride compounds, oligomers, or polymers, and polyurea compounds or oligomers.

The coating composition in certain embodiments includes an aminoplast as a crosslinker. An aminoplast for purposes of the invention is a material obtained by reaction of an activated nitrogen with a lower molecular weight aldehyde, optionally further reacted with an alcohol (preferably a mono-alcohol with one to four carbon atoms) to form an ether group. Preferred examples of activated nitrogens are activated amines such as melamine, benzoguanamine, cyclohexylcarboguanamine, and acetoguanamine; ureas, including urea itself, thiourea, ethyleneurea, dihydroxyethyleneurea, and guanylurea; glycoluril; amides, such as dicyandiamide; and carbamate functional compounds having at least one primary carbamate group or at least two secondary carbamate groups.

The activated nitrogen is reacted with a lower molecular weight aldehyde. The aldehyde may be selected from formaldehyde, acetaldehyde, crotonaldehyde, benzaldehyde, or other aldehydes used in making aminoplast resins, although formaldehyde and acetaldehyde, especially formaldehyde, are preferred. The activated nitrogen groups are at least partially alkylolated with the aldehyde, and may be fully alkylolated; preferably the activated nitrogen groups are fully alkylolated. The reaction may be catalyzed by an acid, e.g. as taught in U.S. Pat. No. 3,082,180, the contents of which are incorporated herein by reference.

The alkylol groups formed by the reaction of the activated nitrogen with aldehyde may be partially or fully etherified with one or more monofunctional alcohols. Suitable examples of the monofunctional alcohols include, without limitation, methanol, ethanol, propanol, isopropanol, butanol, isobutanol, tert-butyl alcohol, benzyl alcohol, and so on. Monofunctional alcohols having one to four carbon atoms and mixtures of these are preferred. The etherification may be carried out, for example, by the processes disclosed in U.S. Pat. Nos. 4,105,708 and 4,293,692, the disclosures of which are incorporated herein by reference.

The aminoplast may be at least partially etherified, and in various embodiments the aminoplast is fully etherified. For example, the aminoplast compounds may have a plurality of methylol and/or etherified methylol, butylol, or alkylol groups, which may be present in any combination and along with unsubstituted nitrogen hydrogens. One nonlimiting example of a fully etherified melamine-formaldehyde resin is hexamethoxymethyl melamine. Aminoplast crosslinkers may be used as crosslinkers for carbamate, terminal urea, and hydroxyl containing polymers.

The coating composition in certain embodiments includes a polyisocyanate or blocked polyisocyanate crosslinker. Useful polyisocyanate crosslinkers include, without limitation, isocyanurates, biurets, allophanates, uretdione compounds, and isocyanate-functional prepolymers such as the reaction product of one mole of a triol with three moles of a diisocyanate. The polyisocyanate may be blocked with lower alcohols, oximes, or other such materials that volatilize at curing temperature to regenerate the isocyanate groups.

An isocyanate or blocked isocyanate is may be used in a 0.1-1.1 equivalent ratio, or in an equivalent ratio of 0.5-1.0 to each equivalent of functional groups reactive with it available from the crosslinkable binder resin.

Epoxide-functional crosslinkers may be used with carboxyl- or amine-functional crosslinkable resins. Illustrative examples of epoxide-functional crosslinkers are all known epoxide-functional polymers and oligomers. Nonlimiting examples of epoxide-functional crosslinking agents are polyglycidyl ethers, polyglycidyl esters, glycidyl methacrylate polymers, and isocyanurate-containing, epoxide-functional materials such as trisglycidyl isocyanurate and the reaction product of glycidol with an isocyanate-functional isocyanurate such as the trimer of isophorone diisocyanate (IPDI).

Preferably, the amount of component (ii) in the coating composition of the present invention is in a range of 10 to 30% by weight (for example 10, 15, 20, 25 or 30% by weight), preferably in a range of 12 to 20% by weight, based on the weight of the coating composition.

### Carbon Black

The coating composition of the present invention comprises a carbon black as component (iii).

Carbon black in general is produced by the thermal decomposition of hydrocarbons (liquid and gaseous hydrocarbons) under controlled conditions, i.e. by an oxidative pyrolysis process, most commonly through incomplete combustion of the feedstock. The most common source of feedstock for the production of carbon black is a heavy stream of hydrocarbon derived from coal or crude oil processing, which is referred to as carbon black oil (CBO). CBO usually mainly contains polycyclic aromatic hydrocarbon feedstock oils. Natural gas, distillates from coal tar (carbochemical oils) or residual oils that are created by catalytic cracking of petroleum fractions and olefins manufactured by the thermal cracking of naphtha or gasoil (petrochemical oil) are the key sources of this raw material. Production methods differ based on the way the heat and decomposition stages are arranged. The resulting carbon black product (e.g., lamp black, gas black or furnace black) is filtered from the off-gassing of the production process. Manufacturing methods include furnace, gas, lamp and thermal black processes.

More than 98% of the world's annual carbon black production is achieved through the furnace black process. The furnace black method is continuous and uses liquid and gaseous hydrocarbons as feedstock. The heated liquid feedstock is sprayed into a heat source generated by the combustion of natural gas or fuel oil and pre-heated air. Because it occurs at a very high temperature, the reaction is confined to a refractory-lined furnace. After the carbon black is formed, the process mixture is quenched by the injection of water. This also prevents any unwanted secondary reactions. The carbon clack-laden gas then passes through a heat exchanger for further cooling while simultaneously heating the required pre-heated air for process combustion. A bag filter separates the carbon black particles from the gas stream. The gases produced by the reaction are combustible and in most cases are burned in a boiler to generate steam and/or electricity or are alternatively flared. The carbon black collected by the filter has a very low bulk density and, depending on the application, is usually pelletized or further densified to facilitate onward handling.

The gas black process uses vaporized oils as a feedstock. The oil is heated and the resultant vapors are carried by hydrogen rich gas into a tube fitted with numerous burners. The individual particles impinge on the surface of a water-cooled drum. A portion of the carbon black generated is deposited on the roller, while the rest enters the filter system. Then the two carbon black streams are combined. Onward processing is similar to the furnace black process. The thermal black process of producing carbon black is a semi-batch method, with natural gas as the most commonly used feedstock, although higher grade hydrocarbon oils can also be used. It involves the thermal decomposition of the feedstock in a refractory lined vessel, which decomposes the natural gas into carbon black and hydrogen.

Lamp black is a specialty carbon black produced through the incomplete combustion of carbon black oil similar to the furnace black process, except that combustion occurs in a large, open, shallow vessel. Lamp black is the oldest industrial scale production process for carbon Black still in use.

The carbon black that is applicable to a coating composition can be used in the present invention. A skilled person is able to select appropriate carbon black according to practical applications.

In a preferred embodiment of the present invention, the carbon black used in the coating composition of the present invention is gas black.

In a preferred embodiment of the present invention, the carbon black used in the present invention has an oil absorption in a range of 100 to 200 mL/100 g, preferably 130 to 170 mL/100 g, more preferably 140 to 160 mL/100 g, measured according to GB/T 5211.15-2014.

In a preferred embodiment of the present invention, the carbon black used in the coating composition of the present invention is C. I. Pigment Black 7, such as FW 2 from Evonik Industries AG, Germany.

Preferably, the amount of component (iii) in the coating composition of the present invention is in a range of 0.05-0.3% by weight (for example 0.05, 0.08, 0.1, 0.15, 0.2, 0.25 or 0.3% by weight), preferably in a range of 0.05-0.2% by weight, based on the weight of the coating composition, based on the weight of the coating composition.

### Aluminum

The coating composition of the present invention comprises aluminum as component (iv). Aluminum may be used in any appropriate form that is applicable as a component of a coating composition and may be selected by a skilled person according to practical applications. Preferably aluminum may be used in the present invention in form of powder. More preferably, the D50 particle size of the aluminum used in the present invention is in the range of 5 to 40 μm, preferably in the range of 10 to 35 μm. For example, aluminum may be those commercial available, such as Stapa Hydrolan 2154, from ECKART, Germany.

Preferably, the amount of component (iv) in the coating composition of the present invention is in a range of 0.5-2.0% by weight, preferably in a range of 0.8-1.8% by weight, based on the weight of the coating composition.

### Water

The coating composition of the present invention comprises water as component (v).

Component (v) may be selected from a group consisting of deionized water, distilled water, and pure water. Preferably, component (v) is deionized water.

Preferably, the amount of component (v) in the coating composition of the present invention is in a range of 20-70% by weight (for example 20, 30, 40, 50, 60 or 70% by weight), preferably in a range of 30-60% by weight, more preferably in a range of 50-65% by weight based on the weight of the coating composition.

### Solvent

The coating composition of the present invention may further comprise one or more solvents as component (vi). Nonlimiting examples of suitable solvents include aromatic hydrocarbons, ketones, esters, glycol ethers, and esters of glycol ethers. Specific examples include, without limitation, methyl ethyl ketone, methyl isobutyl ketone, m-amyl acetate, ethylene glycol butyl ether and ethylene glycol monobutyl ether acetate, propylene glycol monomethyl ether and propylene glycol monomethyl ether acetate, xylene, ethanol, propanol, isopropanol, n-butanol, isobutanol, tert-butanol, N-methyl pyrrolidone, N-ethyl pyrrolidone, Aromatic 100, Aromatic 150, naphtha, mineral spirits, butyl glycol, and so on.

In the present invention, the concept of the term “solvent” does not encompass water.

Preferably, the amount of component (vi) in the coating composition of the present invention is in a range of 10-30% by weight (for example 10, 15, 20, 25 or 30% by weight), preferably in a range of 10-16% by weight, based on the weight of the coating composition.

### Additives

The coating composition of the present invention may further comprise an additive as component (vii), preferably the additive is selected from a group consisting of antifoaming agents, ultraviolet absorbers, rheology control agents, antioxidants, surface conditioners, dispersing agents, anti-settling agents, and pH adjusting agents.

pH adjusting agents may be selected from a group consisting of bases and amines, such as ammonia, triethyl amine, and alcohol amines, preferably alcohol amines of no or thin smell. In a preferred embodiment of the invention, the pH adjusting agent in the coating composition of the present invention is AMP-95 from ANGUS Chemical Company, USA.

The amount of component (vii) in the coating composition of the present invention may be determined by a skilled person according to practical application. Preferably, the amount of component (vii) in the coating composition of the present invention may be in a range of 0-10% by weight, preferably in a range of 0-8% by weight, based on the weight of the coating composition.

In an embodiment, the coating composition of the present invention comprises components of:
(i) a pigment, wherein the pigment is the pigment composition of the present invention, comprised in an amount of 0.3 to 3% by weight, preferably in an amount of 0.5 to 2% by weight, based on the weight of the coating composition;
(ii) a binder, comprised in an amount of 10 to 30% by weight, preferably in an amount of 12 to 20% by weight, based on the weight of the coating composition;
(iii) carbon black, preferably gas black, comprised in an amount of 0.05 to 0.3% by weight, preferably in an amount of 0.05 to 0.2% by weight, based on the weight of the coating composition;
(iv) aluminum, comprised in an amount of 0.5 to 2.0% by weight, preferably in an amount of 0.8 to 1.8% by weight, based on the weight of the coating composition; and
(v) water, comprised in an amount of 20 to 70% by weight, preferably in an amount of 30 to 60% by weight, more preferably in a range of 50-65% by weight, based on the weight of the coating composition, preferably the composition has a pH in a range of from 7.5 to 8.5, preferably from 7.8 to 8.2.

In a further embodiment, the coating composition of the present invention comprises components of:
(i) a pigment, wherein the pigment is the pigment composition of the present invention, comprised in an amount of 0.3 to 3% by weight, preferably in an amount of 0.5 to 2% by weight, based on the weight of the coating composition;
(ii) a binder, comprised in an amount of 10 to 30% by weight, preferably in an amount of 12 to 20% by weight, based on the weight of the coating composition;
(iii) carbon black, preferably gas black, comprised in an amount of 0.05 to 0.3% by weight, preferably in an amount of 0.05 to 0.2% by weight, based on the weight of the coating composition;
(iv) aluminum, comprised in an amount of 0.5 to 2.0% by weight, preferably in an amount of 0.8 to 1.8% by weight, based on the weight of the coating composition;
(v) water, comprised in an amount of 20 to 70% by weight, preferably in an amount of 30 to 60% by weight, more preferably in a range of 50-65% by weight, based on the weight of the coating composition; and
(vi) a solvent, comprised in an amount of 10 to 30% by weight, preferably in an amount of 10-16% by weight, based on the weight of the coating composition, preferably the composition has a pH in a range of from 7.5 to 8.5, preferably from 7.8 to 8.2.

In a further embodiment, the coating composition of the present invention comprises components of:
(i) a pigment, wherein the pigment is the pigment composition of the present invention, comprised in an amount of 0.3 to 3% by weight, preferably in an amount of 0.5 to 2% by weight, based on the weight of the coating composition;
(ii) a binder, comprised in an amount of 10-30% by weight, preferably in an amount of 12 to 20% by weight, based on the weight of the coating composition;
(iii) carbon black, preferably gas black, comprised in an amount of 0.05-0.3% by weight, preferably in an amount of 0.05-0.2% by weight, based on the weight of the coating composition;
(iv) aluminum, comprised in an amount of 0.5-2.0% by weight, preferably in an amount of 0.8 to 1.8% by weight, based on the weight of the coating composition;
(v) water, comprised in an amount of 20-70% by weight, preferably in an amount of 30-60% by weight, more preferably in a range of 50-65% by weight, based on the weight of the coating composition;
(vi) a solvent, comprised in an amount of 10-30% by weight, preferably in an amount of 10-16% by weight, based on the weight of the coating composition; and
(vii) an additive, comprised in an amount of 0-10% by weight, preferably in an amount of 0-8% by weight, based on the weight of the coating composition, preferably the additive is selected from a group consisting of antifoaming agents, ultraviolet absorbers, rheology control agents, antioxidants, surface conditioners, dispersing agents, anti-settling agents, and pH adjusting agents, preferably the composition has a pH in a range of from 7.5 to 8.5, preferably from 7.8 to 8.2.

The coating composition of the present invention can be prepared by a skilled person using a process known in the art. For example, the coating composition of the present invention may be prepared by adding all the components at the same time with stirring.

Preferably, before forming the coating composition of the present invention, when the pigments, carbon black and/or aluminum are used in form of dry powders or particles, they are pre-dispersed in a binder and/or a solvent to form a pre-dispersion respectively. The binder and the solvent used for forming the pre-dispersion are those applicable for the present invention. For example, they may be the binder and the solvent as disclosed above. Preferably, the binder and the solvent used for forming the pre-dispersion are parts of the binder and the solvent in the coating composition of the present invention. In a preferred embodiment, the coating composition of the present invention is prepared by a process comprising:
taking a part of the binder and a part of the solvent used for the coating composition to form a mixture and pre-dispersing aluminum into the mixture to form an aluminum pre-dispersion with stirring, preferably with the ratio by weight of aluminum:binder:solvent of 1:1:1;
preparing a carbon black pre-dispersion and a pigment pre-dispersion in the same way;
adding the remaining binder and solvent with stirring to the aluminum pre-dispersion, to form a dispersion; then
adding the carbon black pre-dispersion and the pigment pre-dispersion into the dispersion to form the coating composition.

A coating film having a color-travel property is obtained or obtainable from the invention coating composition. The coating film has a distinctive grey color travel of from blue-grey-red with observing angle being changed. Specifically, the coating film has CIELAB color space with L*, a*, b* values as defined in at least three of conditions I, II, III, IV and V, preferably at least four of conditions I, II, III, IV and V and more preferably, all of conditions I, II, III, IV and V:

| | Observing | | | |
|---|---|---|---|---|
| Condition | angle | L* | a* | b* |
| I | 15° | from 47 to 67, | from −11 to 5, | from −13 to 7, |
| | | preferably | preferably | preferably |
| | | from 54 to 62 | from −11 to −2 | from −13 to −5 |
| II | 25° | from 30 to 50, | from −8 to 2, | from −11 to 5, |
| | | preferably | preferably | preferably |
| | | from 39 to 45 | from −8 to −1 | from −10 to −5 |
| III | 45° | from 12 to 32, | from −3 to 3, | from −7 to 1, |
| | | preferably | preferably | preferably |
| | | from 18 to 28 | from −2 to 0 | from −6 to −2 |
| IV | 75° | from 4 to 24, | from 2 to 8, | from −2 to 4, |
| | | preferably | preferably | preferably |
| | | from 8 to 18 | from 3 to 6 | from − 1 to 3 |
| V | 110° | from 0 to 20, | from 3 to 9, | from −1 to 5, |
| | | preferably | preferably | preferably |
| | | from 5 to 12 | from 3 to 8 | from 0 to 4 |

The coating film obtained from the invented coating composition has CIEHLC color space with C*, h° values as defined in at least three of conditions VI, VII, VIII, XI and X, preferably at least four of conditions VI, VII, VIII, IX and X, and more preferably all of conditions VI, VII, VIII, IX and X:

| | Observing | | |
|---|---|---|---|
| Condition | angle | C* | h° |
| I | 15° | from 9 to 15, | from 210 to 250, preferably |
| | | preferably | from 215 to 240 |
| | | from 9 to 14 | |
| II | 25° | from 6 to 12, | from 220 to 260, preferably |
| | | preferably | from 225 to 250 |
| | | from 7 to 10 | |
| III | 45° | from 1 to 7, | from 250 to 290, preferably |
| | | preferably | from 250 to 285 |
| | | from 3 to 5 | |
| IV | 75° | from 2 to 8, | from 0 to 20, preferably from 0 |
| | | preferably | to 18; or from 350 to 360, , |
| | | from 2 to 6 | preferably from 355 to 360 |
| V | 110° | from 3 to 9, | from 8 to 30, preferably from 9 |
| | | preferably | to 30 |
| | | from 4 to 8 | |

### Coating Film

The present invention further provides a coating film having CIELAB color space with L*, a*, b* values as defined in at least three of conditions I, II, III, IV and V, preferably at least four of conditions I, II, III, IV and V and more preferably, all of conditions I, II, III, IV and V:

| | Observing | | | |
|---|---|---|---|---|
| Condition | angle | L* | a* | b* |
| I | 15° | from 47 to 67, | from −11 to 5, | from −13 to 7, |
| | | preferably | preferably | preferably |
| | | from 54 to 62 | from −11 to −2 | from −13 to −5 |
| II | 25° | from 30 to 50, | from −8 to 2, | from −11 to 5, |
| | | preferably | preferably | preferably |
| | | from 39 to 45 | from −8 to −1 | from −10 to −5 |
| III | 45° | from 12 to 32, | from −3 to 3, | from −7 to 1, |
| | | preferably | preferably | preferably |
| | | from 18 to 28 | from −2 to 0 | from −6 to −2 |
| IV | 75° | from 4 to 24, | from 2 to 8, | from −2 to 4, |
| | | preferably | preferably | preferably |
| | | from 8 to 18 | from 3 to 6 | from −1 to 3 |
| V | 110° | from 0 to 20, | from 3 to 9, | from −1 to 5, |
| | | preferably | preferably | preferably |
| | | from 5 to 12 | from 3 to 8 | from 0 to 4 |

The present invention further provides a coating film having CIEHLC color space with C* and h° values as defined in at least three of conditions VI, VII, VIII, IX and X, preferably at least four of conditions VI, VII, VIII, IX and X, and more preferably all of conditions VI, VII, VIII, IX and X:

| | Observing | | |
|---|---|---|---|
| Condition | angle | C* | h° |
| VI | 15° | from 9 to 15, | from 210 to 250, preferably |
| | | preferably | from 215 to 240 |
| | | from 9 to 14 | |
| VII | 25° | from 6 to 12, | from 220 to 260, preferably |
| | | preferably | from 225 to 250 |
| | | from 7 to 10 | |
| VIII | 45° | from 1 to 7, | from 250 to 290, preferably |
| | | preferably | from 250 to 285 |
| | | from 3 to 5 | |
| IX | 75° | from 2 to 8, | from 0 to 20, preferably from 0 |
| | | preferably | to 18; orfrom 350 to 360, , |
| | | from 2 to 6 | preferably from 355 to 360 |
| X | 110° | from 3 to 9, | from 8 to 30, preferably from 9 |
| | | preferably | to 30 |
| | | from 4 to 8 | |

In an embodiment of the invention, the coating film of the present invention is obtained from the pigment composition of the present invention.

### Colored Article

The present invention further relates to a colored article, wherein the colored article has CIELAB color space with L*, a*, b* values as defined in at least three of conditions I, II, III, IV and V, preferably at least four of conditions I, II, III, IV and V, and more preferably all of conditions I, II, III, IV and V:

| | Observing | | | |
|---|---|---|---|---|
| Condition | angle | L* | a* | b* |
| I | 15° | from 47 to 67, | from −11 to 5, | from −13 to 7, |
| | | preferably | preferably | preferably |
| | | from 54 to 62 | from −11 to −2 | from −13 to −5 |
| II | 25° | from 30 to 50, | from −8 to 2, | from −11 to 5, |
| | | preferably | preferably | preferably |
| | | from 39 to 45 | from −8 to −1 | from −10 to −5 |
| III | 45° | from 12 to 32, | from −3 to 3, | from −7 to 1, |
| | | preferably | preferably | preferably |
| | | from 18 to 28 | from −2 to 0 | from −6 to −2 |
| IV | 75° | from 4 to 24, | from 2 to 8, | from −2 to 4, |
| | | preferably | preferably | preferably |
| | | 8 to 18 | from 3 to 6 | from −1 to 3 |
| V | 110° | from 0 to 20, | from 3 to 9, | from −1 to 5, |
| | | preferably | preferably | preferably |
| | | 5 to 12 | from 3 to 8 | from 0 to 4 |

The present invention further relates to a colored article, wherein the colored article has CIEHLC color space with C* and h° values as defined in at least three in conditions VI, VII, VIII, IX and X, preferably at least four of conditions VI, VII, VIII, IX and X, and more preferably all of conditions VI, VII, VIII, IX and X:

| Condition | Observing angle | C* | h° |
|---|---|---|---|
| VI | 15° | from 9 to 15, | from 210 to 250, |
| | | preferably | preferably from 215 to |
| | | from 9 to 14 | 240 |
| VII | 25° | from 6 to 12, | from 220 to 260, |
| | | preferably | preferably from 225 to |
| | | from 7 to 10 | 250 |
| VIII | 45° | from 1 to 7, | from 250 to 290, |
| | | preferably | preferably from 250 to |
| | | from 3 to 5 | 285 |
| IX | 75° | from 2 to 8, | from 0 to 20, preferably |
| | | preferably | from 0 to 18; or from |
| | | from 2 to 6 | 350 to 360,, preferably |
| | | | from 355 to 360 |
| X | 110° | from 3 to 9, | from 8 to 30, preferably |
| | | preferably | from 9 to 30 |
| | | from 4 to 8 | |

The colored article of the present invention is obtained by coating an article with the coating composition of the present invention or is an article having a coating film of the present invention.

In an embodiment, the colored article of the present invention comprises a primer, a coating film and optionally a clearcoat.

The colored article of the present invention can be obtained by a skilled person with conventional procedures. In an embodiment of the present invention, the colored article of the present invention is prepared by a process comprising:
providing an article,
applying a primer on a surface of the article, then drying the primer to form a primer film, preferably drying the primer at room temperature for such as 5 min, to form a primer film preferably having a thickness such as in a range of 12 to 15 μm; and
applying a coating composition of the present invention on the formed primer film, then drying the coating composition to form a coating film, preferably drying the coating composition at room temperature for such as 5 min and then at such as 80° C. for such as 5 min to form a coating film preferably having a thickness such as in a range of 12 to 15 μm, thus obtaining the colored article of the present invention.

Preferably, a clearcoat is further applied on the formed coating film, then drying the clearcoat, preferably at room temperature for such as 7 min and then such as at 140° C. for 30 min, to form a clearcoat film preferably having a thickness in a range of 40 to 45 μm.

In an embodiment of the invention, a colored article is prepared with a process comprising:
(1) applying a primer on a surface of an article, then drying the primer at room temperature for 5 min, to form a primer film preferably having a thickness in a range of 12 to 15 μm; and
(2) applying a coating composition of the present invention on the primer film formed in step (1), then drying the coating composition at room temperature for 5 min and then at 80° C. for 5 min, to form a coating film preferably having a thickness such as in a range of 12 to 15 μm, thereby forming the colored article.

In an embodiment of the invention, a colored article is prepared with a process comprising:
(1) applying a primer on a surface of an article, then drying the primer at room temperature for 5 min, to form a primer film preferably having a thickness in a range of 12 to 15 μm;
(2) applying a coating composition of the present invention on the primer film formed in step (1), then drying the coating composition at room temperature for 5 min and then at 80° C. for 5 min, to form a coating film preferably having a thickness in a range of 12 to 15 μm; and
(3) applying a clearcoat on the coating film formed in step (2), then drying the clearcoat at room temperature for 7 min and then at 140° C. for 30 min, to form a clearcoat film preferably having a thickness in a range of 40 to 45 μm, thereby forming the colored article.

Many different types of articles can be used in the present invention, including metal or metallic articles such as bare steel, phosphated steel, galvanized steel, or aluminum; and non-metallic articles, such as plastics and composites.

The primer used in the present invention may be an electrodeposition (electrocoat) primer. The electrodeposition composition can be any electrodeposition composition used in such as automotive vehicle coating operations. Non-limiting examples of electrocoat compositions include the CATHOGUARD® electrocoating compositions sold by BASF Corporation, such as CATHOGUARD® 500. Electrodeposition coating baths usually comprise an aqueous dispersion or emulsion including a principal film-forming epoxy resin having ionic stabilization (e.g., salted amine groups) in water or a mixture of water and organic solvent. Emulsified with the principal film-forming resin is a crosslinking agent that can react with functional groups on the principal resin under appropriate conditions, such as with the application of heat, and so cure the coating. Suitable examples of crosslinking agents, include, without limitation, blocked polyisocyanates. The electrodeposition coating compositions usually include one or more pigments, catalysts, plasticizers, coalescing aids, antifoaming aids, flow control agents, wetting agents, surfactants, UV absorbers, HALS compounds, antioxidants, and other additives.

The clearcoat applicable for the present invention may be selected by a skilled person. For example, it may be clearcoat composition FF99-0345 commercially available from BASF.

The present invention provides the distinctive grey color travel with a combination of specific pigments of 1) high chroma blue pigment with greenish hue, the main color contributor for observing angle of 15°; 2) magenta pigment with mid chroma and semi-transparency, diluting blue color at observing angle of 45° without impact on the color at observing angle of 15°; and 3) iron oxide red opaque pigment, providing maroon hue at observing angle of 75° without haze, without relying on optical effect pigment, thus avoiding disadvantages caused by optical effect pigment, such as pigment orientation issue, color quality issue and batch-to-batch color stability issue, and realizing stable and extensive applications of the pigment composition and the coating composition of the invention, such as in the mass production of the target products, e.g., automotives and household appliances. Furthermore, when a product coated with the coating composition of the invention is damaged, for example is cut or scratched, it can easily be repaired by the coating composition to obtain the original appearance.

### EMBODIMENTS

### Embodiment 1

A metallic effect coating composition comprising
(A) a pigment composition comprising:
   (A-1) a yellowish red pigment;
   (A-2) a magenta pigment; and
   (A-3) a greenish blue pigment,
(B) a binder;
(C) carbon black, preferably gas black; and
(D) aluminum, wherein the sum of weight perctanges of components (A-1), (A-2) and (A-3) is at least 80%, preferably at least 95% and more preferably 100% by weight based on the total weight of component (A).

### Embodiment 2

The coating composition according to embodiment 1, wherein said component (A) comprises
from 20% to 60%, preferably from 40% to 60% by weight of component (A-1),
from 10% to 40%, preferably from 10% to 20% by weight of component (A-2), and
from 20% to 50%, preferably from 20% to 40% by weight of component (A-3), based on the total weight of component (A).

### Embodiment 3

The coating composition according to any one of embodiments 1 to 2, wherein
said component (A-1) is one selected from C.I. Pigment Red 101 and C.I. Pigment Red 254, said component (A-2) is one selected from C.I. Pigment Red 122, C.I. Pigment Red 202, C.I. Pigment Violet 19 and a mixture of C.I. Pigment Red 177 and C.I. Pigment Violet 23 in a ratio by weight of from 1:10 to 10:1 and preferably from 1:10 to 2:1, and
said component (A-3) is one selected from C.I. Pigment Blue 15, a mixture of C.I. Pigment Blue 15 and C.I. Pigment Green 7 in a ratio by weight of from 1:2 to 2:1, more preferably from 1:1.2 to 1.2:1, and a mixture of C.I. Pigment Blue 15 and C.I. Pigment Green 36 in a ratio by weight of from 1:1 to 25:1 and preferably from 1:1 to 20:1, wherein said component (A-3) is preferably selected from the mixture of C.I. Pigment Blue 15 and C.I. Pigment Green 7 or the mixture of C.I. Pigment Blue 15 and C.I. Pigment Green 36.

### Embodiment 4

The coating composition according to any one of embodiments 1 to 3, wherein it comprises from 0.3% to 3% and preferably from 0.5% to 2% by weight of component (A), based on the total weight of the coating composition.

### Embodiment 5

The coating composition according to any one of embodiments 1 to 4, wherein said binder is at least three selected from a group consisting of polyester, polyurethane, poly(meth)acrylates, cellulose acetate butyrate resin and melamine resin.

### Embodiment 6

The coating composition according to any one of embodiments 1 to 5, wherein it comprises
from 10% to 30%, preferably from 12% to 20% by weight of component (B;
from 0.05% to 0.3%, preferably from 0.05% to 0.2% by weight of component (C); and
from 0.5% to 2.0%, preferably from 0.8% to 1.8% by weight of component (D), based on the total weight of the coating composition.

### Embodiment 7

The coating composition according to any one of embodiments 1 to 6, it further comprises from 20% to 70%, preferably from 30% to 65% and more preferably from 50% to 65% by weight of water, based on the total weight of the coating composition.

### Embodiment 8

The coating composition according to any one of embodiments 1 to 7, it further comprising from 10% to 30%, preferably from 10% to 16% by weight of solvent, based on the total weight of the coating composition.

### Embodiment 9

The coating composition according to any one of embodiments 1 to 8, it further comprises at least three additive selected from a group consisting of antifoaming agents, ultraviolet absorbers, rheology control agents, antioxidants, surface conditioners, dispersing agents, anti-settling agents, and pH adjusting agents, wherein the amount of said additive(s) is no more than 10% and preferably no more than 8% by weight based on the total weight of the coating composition.

### Embodiment 10

The coating composition according to any one of embodiments 1 to 9, wherein it has a pH value in a range of from 7.5 to 8.5 and preferably from 7.8 to 8.2.

### Embodiment 11

The coating composition according to any one of embodiments 1 to 10 wherein the coating composition is capable of forming a coating film having CIELAB color space with L*, a*, b* values as defined in at least three of conditions I, II, III, IV and V, preferably at least four of conditions I, II, III, IV and V, and more preferably, all of conditions I, II, III, IV and V:

| | Observing | | | |
|---|---|---|---|---|
| Condition | angle | L* | a* | b* |
| I | 15° | from 47 to | from −11 to 5, | from −13 to 7, |
| | | 67, preferably | preferably | preferably |
| | | from 54 to 62 | from −11 to −2 | from −13 to −5 |
| II | 25° | from 30 to 50, | from −8 to 2, | from −11 to 5, |
| | | preferably | preferably | preferably |
| | | from 39 to 45 | from −8 to −1 | from −10 to −5 |
| III | 45° | from 12 to 32, | from −3 to 3, | from −7 to 1, |
| | | preferably | preferably | preferably |
| | | from 18 to 28 | from −2 to 0 | from −6 to −2 |
| IV | 75° | from 4 to 24, | from 2 to 8, | from −2 to 4, |
| | | preferably | preferably | preferably |
| | | from 8 to 18 | from 3 to 6 | from −1 to 3 |
| V | 110° | from 0 to 20, | from 3 to 9, | from −1 to 5, |
| | | preferably | preferably | preferably |
| | | from 5 to 12 | from 3 to 8 | from 0 to 4 |

### Embodiment 12

The coating composition according to any one of embodiments 1 to 11, wherein the coating composition is capable of forming a coating film having CIEHLC color space with C*, h° values as defined in at least three of conditions VI, VII, VIII, IX and X, preferably at least four of conditions VI, VII, VIII, IX and X, and more preferably all of conditions VI, VII, VIII, IX and X:

| Condi- | Observing | | |
|---|---|---|---|
| tion | angle | C* | h° |
| VI | 15° | from 9 to 15, preferably | from 210 to 250, |
| | | from 9 to 14 | preferably from 215 to |
| | | | 240 |
| VII | 25° | from 6 to 12, preferably | from 220 to 260, |
| | | from 7 to 10 | preferably from 225 to |
| | | | 250 |
| VIII | 45° | from 1 to 7, preferably | from 250 to 290, |
| | | from 3 to 5 | preferably from 250 to |
| | | | 285 |
| IX | 75° | from 2 to 8, preferably | 0 to 20, preferably 0 to |
| | | from 2 to 6 | 18 or 350 to 360, |
| | | | preferably 355 to 360 |
| X | 110° | from 3 to 9, preferably | from 8 to 30, preferably |
| | | from 4 to 8 | from 9 to 30 |

### Embodiment 13

A coating film obtained from the coating composition according to any one of embodiments 1 to 10, wherein the CIELAB color space of said coating film has L*, a, b* values as defined in at least three of conditions I, II, III, IV and V, preferably at least four of conditions I, II, III, IV and V, and more preferably, all of conditions I, II, III, IV and V:

| | Observing | | | |
|---|---|---|---|---|
| Condition | angle | L* | a* | b* |
| I | 15° | from 47 to 67, | from −11 to 5, | from −13 to 7, |
| | | preferably | preferably | preferably |
| | | from 54 to 62 | from −11 to −2 | from −13 to −5 |
| II | 25° | from 30 to 50, | from −8 to 2, | from −11 to 5, |
| | | preferably | preferably | preferably |
| | | from 39 to 45 | from −8 to −1 | from −10 to −5 |
| III | 45° | from 12 to 32, | from −3 to 3, | from −7 to 1, |
| | | preferably | preferably | preferably |
| | | from 18 to 28 | from −2 to 0 | from −6 to −2 |
| IV | 75° | from 4 to 24, | from 2 to 8, | from −2 to 4, |
| | | preferably | preferably | preferably |
| | | from 8 to 18 | from 3 to 6 | from −1 to 3 |
| V | 110° | from 0 to 20, | from 3 to 9, | from −1 to 5, |
| | | preferably | preferably | preferably |
| | | from 5 to 12 | from 3 to 8 | from 0 to 4 |

### Embodiment 14

The coating film obtained from the coating composition according to any one of embodiments 1 to 10, condition wherein the CIEHLC color space of said coating film has C*, h° values as defined in at least three of conditions VI, VII, VIII, IX and X, preferably at least four of conditions VI, VII, VIII, IX and X, and more preferably all of conditions VI, VII, VIII, IX and X:

| Condi- | Observing | | |
|---|---|---|---|
| tion | angle | C* | h° |
| VI | 15° | from 9 to 15, preferably | from 210 to 250, |
| | | from 9 to 14 | preferably from 215 to |
| | | | 240 |
| VII | 25° | from 6 to 12, preferably | from 220 to 260, |
| | | from 7 to 10 | preferably from 225 to |
| | | | 250 |
| VIII | 45° | from 1 to 7, preferably | from 250 to 290, |
| | | from 3 to 5 | preferably from 250 to |
| | | | 285 |
| IX | 75° | from 2 to 8, preferably | from 0 to 20, preferably |
| | | from 2 to 6 | from 0 to 18, or from |
| | | | 350 to 360, preferably |
| | | | from 355 to 360 |
| X | 110° | from 3 to 9, preferably | from 8 to 30, preferably |
| | | from 4 to 8 | from 9 to 30 |

### EXAMPLES

The present invention will be better understood in view of the following non-limiting examples. The examples do not limit the scope of the invention as described and claimed.

### Preparation of the Colored Plate

For measuring the CIELAB color space, a series of colored plates were prepared.

In the examples, the prepared coating compositions were used as basecoat. In the processes for preparing the colored plates, primer (if any) and basecoat were applied by a Bell-bell spray primer and basecoat applying process, with parameters as follows:

| Equipment | Machine | Kohne6 1.0 | | |
|---|---|---|---|---|
| | Booth condition | 23° C., 65% humidity | | |
| | Test Purpose | Color matching | | |
| | Atomizer | Durr Ecobell2 | | |
| | | (External charge) | | |
| | Bell cup type | N 16010059 | | |
| | Bell cup diameter | 65 mm | | |
| | (mm) | | | |
| | | Layer | | |
| | | Primer | Basecoat | |
| | Kind of stroke | Stepwise | Stepwise | Stepwise |
| Application | Shaping Air IN/Atom | 330.0 | 270.0 | 240.0 |
| parameter | air(NL/min) | | | |
| | Shaping Air OUT/Fan | 0.0 | 0.0 | 0.0 |
| | air(NL/min) | | | |
| | Flowrate(NL/min) | 420.0 | 310.0 | 180.0 |
| | Right end position | 0.0 | 0.0 | 0.0 |
| | (mm) | | | |
| | Left end position (mm) | 1400.0 | 1400.0 | 1400.0 |
| | Start position (mm) | 50.0 | 50.0 | 125.0 |
| | End position (mm) | 950.0 | 950.0 | 1025.0 |
| | Rotation(krpm) | 50.0 | 50.0 | 50.0 |
| | Voltage/current | 350.0 | 350.0 | 350.0 |
| | (kv/uA) | | | |
| | Speed(mm/s) | 440.0 | 400.0 | 400.0 |
| | Distance(mm) | 200.0 | 200.0 | 200.0 |
| | Pass pitch(mm) | 150.0 | 150.0 | 150.0 |
| | Flash time(s) | 300.0 | 90.0 | 300.0 |

| | | |
|---|---|---|
| Film build(μm) | 18-20 | 10-14 |

Clearcoat (if any) was applied by a process with parameters as follows:

| Equipment | Machine | Kohne5 4.0 | |
|---|---|---|---|
| | Booth condition | 23° C., 65% humidity | |
| | Test Purpose | Color matching | |
| | Atomizer | Durr Ecobell2 (Internal charge) | |
| | Bell cup type | N 16010061 | |
| | Bell cup diameter (mm) | 65 mm | |
| | | Layer | |
| | | Clearcoat | Clearcoat |
| | Kind of stroke | Stepwise | Stepwise |
| Application | Shaping Air IN/Atom | 280.0 | 280.0 |
| parameter | air(NL/min) | | |
| | Shaping Air OUT/Fan | 0.0 | 0.0 |
| | air(NL/min) | | |
| | Flowrate(NL/min) | 300.0 | 300.0 |
| | Right end position (mm) | 20.0 | 20.0 |
| | Left end position (mm) | 1400.0 | 1400.0 |
| | Start position (mm) | 50.0 | 125.0 |
| | End position (mm) | 950.0 | 1025.0 |
| | Rotation(krpm) | 50.0 | 50.0 |
| | Voltage/current(kv/uA) | 65.0 | 65.0 |
| | Speed(mm/s) | 400.0 | 400.0 |
| | Distance(mm) | 200.0 | 200.0 |
| | Pass pitch(mm) | 150.0 | 150.0 |
| | Flash time(s) | 90.0 | 560.0 |

| | |
|---|---|
| Film build(μm) | 50-55 |

### Measurement of CIELAB and CIEHLC Color Space

CIELAB and CIEHLC color space of each colored plate were measured by BYK mac i from BYK-Chemie GmbH, with 45° illumination of D65 light source, taking observing angles of 15°, 25°, 45°, 75°, and 110°.

### Materials Used in Examples

The materials used in examples are listed as:

| Material | Description |
|---|---|
| substrate plate | a gray colored plate, having CIELAB color parameter |
| | L* of 20 |
| Clearcoat | Progloss FF99-074A, from BASF |
| Solvent | Ethylene glycol monobutyl ether |
| Clear base | Melamine (Euban 28-60, from Mitsui Chemicals) |
| | 7%, Polyurethane 10%, Acrylics 1%, Solvent 15%, |
| | water 67% |
| Additive | Fumed silica |
| Carbon | Gas Black, C.I. Pigment Black 7, Monarch 1400 from |
| Black paste | Cabot, USA, used in form of a paste composition: |
| | carbon black 10%, solvent 15%, water 56%, |
| | Polyester 3%, polyurethane 16% |
| C.I. Pigment | Pigment: SICOTRANS RED L2818, from BASF, |
| Red 101 | Germany, used in form of a paste composition: |
| paste | pigment 48% ( ), solvent 5%, water 30%, |
| | acrylics 17% |
| C.I. Pigment | Pigment: Irgazin Red L3630, from BASF, Germany, |
| Red 254 | used in form of a paste composition: pigment 34.5%, |
| paste | solvent 5.7%, water 40%, acrylics 15.4%, additive 4.4% |
| C.I. Pigment | Pigment: Hostaperm Pink E, from CLARIANT, |
| Red 122 | Switzerland, used in form of a paste composition: |
| paste | pigment 23% solvent 12%, water 50%, |
| | polyurethane 15% |
| C.I. Pigment | Pigment: Cinquasia Magenta L4530, from BASF, |
| Red 202 | Germany, used in form of a paste composition: |
| paste | pigment 23%, solvent 2.6%, water 53%, acrylics |
| | 19%, additive 2.4% |
| C.I. Pigment | Pigment: CINQUASIA VIOLET L5120, from BASF, |
| Violet 19 | Germany, used in form of a paste composition: |
| paste | pigment 18.4%, solvent 5.6% water 51%, |
| | polyurethane 25% |
| C.I. Pigment | Pigment: CINILEX RED SR3C-CR, from CINIC, China, |
| Red 177 | used in form of a paste composition: pigment 30%, |
| paste | solvent 2%, water 51% acrylics 17% |
| C.I. Pigment | Pigment: Hostaperm Violet RL NF, from CLARIANT, |
| Violet 23 | Switzerland, used in form of a paste composition: |
| paste | pigment 18%, solvent 3.4%, water 51%, acrylics 25%, |
| | Additive 2.6% |
| C.I. Pigment | Pigment: combination of C.I. Pigment Blue 15 and |
| Blue | C.I. Pigment Green 7, combination ratio 1:1, Palomar |
| 15/Green | Turqoise 264-4900, from DIC Corporation, Japan, |
| 7-1:1 | used in form of a paste composition: pigment 15%, |
| paste | solvent 5.5%, water 53%, polyurethane 26.5% |
| C.I. Pigment | Pigment: Heliogen Blue L6930, from BASF, |
| Blue 15 | Germany, used in form of a paste composition: |
| paste | pigment 14%, solvent 5.5%, water 54%, |
| | polyurethane 26.5% |
| C.I. Pigment | Pigment: Heliogen Green L9361, from BASF, |
| Green 36 | Germany, used in form of a paste composition: |
| paste | pigment 23.5%, solvent 5%, water 50% |
| | polyurethane 21.5% |
| Al slurry | Stapa Hydrolan S 418, from ECKART, Germany, |
| | used in form of a slurry composition: Al 20%, |
| | polyester 20%, solvent 54%, water 6% |

### Examples 1-16

A series of coating compositions were prepared according to the components and amounts provided in table 1 and table 2, wherein pH of each obtained coating composition was adjusted to 8.2. The obtained coating compositions were applied as basecoat.

TABLE 1

| | Examples | | | | | | | |
|---|---|---|---|---|---|---|---|---|
| Components | 1 | 2 | 3 | 4 | 5 | 6 | 7 | 8 |
| Clear base | 87.3 | 88.08 | 86.97 | 87.7 | 88.05 | 86.98 | 84.2 | 82.88 |
| Additive | — | — | — | — | — | — | 2 | 6 |
| Carbon Black paste | 1.2 | 1.2 | 1.2 | 1.3 | 1.6 | 1.2 | 1 | 2.2 |
| C.I. Pigment Red | — | — | — | — | — | — | — | — |
| 254 paste | | | | | | | | |
| C.I. Pigment Red | 1.5 | 1.5 | 1.5 | 1.5 | 0.85 | 1.5 | 1.9 | 0.8 |
| 101 paste | | | | | | | | |
| C.I. Pigment Red | 1 | 0.66 | — | — | — | — | — | — |
| 122 paste | | | | | | | | |
| C.I. Pigment Red | — | — | 1.33 | 1.1 | — | — | — | — |
| 202 paste | | | | | | | | |
| C.I. Pigment Violet | — | — | — | — | 2 | 1.87 | — | — |
| 19 paste | | | | | | | | |
| C.I. Pigment Red | — | — | — | — | — | — | 0.6 | 0.1 |
| 177 paste | | | | | | | | |
| C.I. Pigment Violet | — | — | — | — | — | — | 0.2 | 0.35 |
| 23 paste | | | | | | | | |
| C.I. Pigment Blue | 3 | — | 3 | — | 2.1 | — | 3.5 | — |
| 15/Green 7-1:1 | | | | | | | | |
| paste | | | | | | | | |
| C.I. Pigment Blue 15 | — | 2.36 | — | 2 | — | 1.9 | — | 2.2 |
| paste | | | | | | | | |
| C.I. Pigment Green | — | 0.2 | — | 0.4 | — | 0.55 | — | 0.07 |
| 36 paste | | | | | | | | |
| Al slurry | 6 | 6 | 6 | 6 | 5.4 | 6 | 6.6 | 5.4 |
| total | 100 | 100 | 100 | 100 | 100 | 100 | 100 | 100 |
| | colored plate | | | | | | | |
| | 1# | 2# | 3# | 4# | 5# | 6# | 7# | 8# |

TABLE 2

| | Examples | | | | | | | |
|---|---|---|---|---|---|---|---|---|
| Components | 9 | 10 | 11 | 12 | 13 | 14 | 15 | 16 |
| Clear base | 88.2 | 88.2 | 88.3 | 88.8 | 84.85 | 88.8 | 88.25 | 86.16 |
| Additive | — | — | — | — | — | — | 1 | 3 |
| Carbon Black paste | 1 | 0.8 | 0.9 | 1 | 1.25 | 1.1 | 1 | 1 |
| C.I. Pigment Red | 1 | 1.2 | 1 | 1.1 | 1 | 0.9 | 1 | 1.1 |
| 254 paste | | | | | | | | |
| C.I. Pigment Red | — | — | — | — | — | — | — | — |
| 101 paste | | | | | | | | |
| C.I. Pigment Red | 1.1 | 1 | — | — | — | — | — | — |
| 122 paste | | | | | | | | |
| C.I. Pigment Red | — | — | 1.2 | 0.7 | — | — | — | — |
| 202 paste | | | | | | | | |
| C.I. Pigment Violet | — | — | — | — | 2.5 | 1.2 | — | — |
| 19 paste | | | | | | | | |
| C.I. Pigment Red | — | — | — | — | — | — | 0.15 | 0.2 |
| 177 paste | | | | | | | | |
| C.I. Pigment Violet | — | — | — | — | — | — | 0.4 | 0.14 |
| 23 paste | | | | | | | | |
| C.I. Pigment Blue | 2.7 | — | 2.6 | — | 2.6 | — | 2.2 | — |
| 15/Green 7-1:1 | | | | | | | | |
| paste | | | | | | | | |
| C.I. Pigment Blue 15 | — | 2.6 | — | 2.4 | — | 2 | — | 2.4 |
| paste | | | | | | | | |
| C.I. Pigment Green | — | 0.2 | — | — | — | — | — | — |
| 36 paste | | | | | | | | |
| Al slurry | 6 | 6 | 6 | 6 | 7.8 | 6 | 6 | 6 |
| total | 100 | 100 | 100 | 100 | 100 | 100 | 100 | 100 |
| | colored plate | | | | | | | |
| | 9# | 10# | 11# | 12# | 13# | 14# | 15# | 16# |

The colored plates in this example were prepared by a process comprising:
(1) applying a primer on a substrate plate, then drying the primer at room temperature for 5 min, to form a primer film having a thickness of 12 μm on the substrate plate;
(2) applying an obtained coating composition on the primer film, then drying the coating composition at room temperature for 5 min and then at 80° C. for 5 min, to form a coating film having a thickness of 12 μm; and
(3) applying a clearcoat on the coating film, then drying the clearcoat at room temperature for 7 min and then at 140° C. for 30 min to form a clearcoat film having a thickness of 40 μm, thereby forming the colored plate.

The coating film obtained from each of the obtained coating compositions completely hided the color of the underneath primer film.

The measured CIELAB and CIEHLC color space of each colored plate prepared from examples 1 to 16 were provided as follows:

colored plate 1#

| Observing | | | | | |
|---|---|---|---|---|---|
| angle | L* | a* | b* | C* | h° |
| 15° | 57.70 | −7.86 | −9.66 | 12.45 | 230.85 |
| 25° | 41.71 | −5.04 | −7.98 | 9.44 | 237.75 |
| 45° | 22.00 | −0.01 | −4.05 | 4.05 | 269.81 |
| 75° | 13.35 | 4.65 | 0.65 | 4.70 | 7.90 |
| 110° | 10.11 | 5.99 | 2.35 | 6.44 | 21.45 |

colored plate 2#

| Observing | | | | | |
|---|---|---|---|---|---|
| angle | L* | a* | b* | C* | h° |
| 15° | 60.15 | −8.27 | −10.37 | 13.26 | 231.43 |
| 25° | 43.86 | −5.50 | −8.58 | 10.19 | 237.35 |
| 45° | 23.25 | −0.38 | −4.38 | 4.40 | 265.08 |
| 75° | 13.94 | 4.51 | 0.57 | 4.55 | 7.18 |
| 110° | 10.50 | 5.96 | 2.44 | 6.44 | 22.29 |

colored plate 3#

| Observing | | | | | |
|---|---|---|---|---|---|
| angle | L* | a* | b* | C* | h° |
| 15° | 56.31 | −8.28 | −11.03 | 13.80 | 233.09 |
| 25° | 41.92 | −5.31 | −9.11 | 10.54 | 239.74 |
| 45° | 22.88 | −0.08 | −4.96 | 4.96 | 269.09 |
| 75° | 13.42 | 5.01 | −0.27 | 5.01 | 356.96 |
| 110° | 9.77 | 6.53 | 1.63 | 6.73 | 14.05 |

colored plate 4#

| Observing | | | | | |
|---|---|---|---|---|---|
| angle | L* | a* | b* | C* | h° |
| 15° | 59.58 | −7.12 | −8.91 | 11.41 | 231.36 |
| 25° | 44.36 | −4.63 | −7.48 | 8.80 | 238.22 |
| 45° | 24.06 | 0.10 | −3.86 | 3.86 | 271.42 |
| 75° | 14.04 | 5.08 | 0.69 | 5.12 | 7.69 |
| 110° | 10.27 | 6.64 | 2.54 | 7.11 | 20.97 |

colored plate 5#

| Observing | | | | | |
|---|---|---|---|---|---|
| angle | L* | a* | b* | C* | h° |
| 15° | 56.26 | −5.49 | −9.76 | 11.19 | 240.65 |
| 25° | 41.30 | −3.23 | −8.02 | 8.64 | 248.08 |
| 45° | 21.45 | 0.86 | −4.19 | 4.28 | 281.64 |
| 75° | 11.70 | 4.95 | 0.14 | 4.95 | 1.66 |
| 110° | 8.11 | 5.93 | 1.80 | 6.20 | 16.90 |

colored plate 6#

| Observing | | | | | |
|---|---|---|---|---|---|
| angle | L* | a* | b* | C* | h° |
| 15° | 61.72 | −9.01 | −10.64 | 13.94 | 229.73 |
| 25° | 44.22 | −5.75 | −8.68 | 10.41 | 236.46 |
| 45° | 23.01 | −0.20 | −4.27 | 4.27 | 267.33 |
| 75° | 13.75 | 4.86 | 0.53 | 4.89 | 6.25 |
| 110° | 10.22 | 6.10 | 2.31 | 6.52 | 20.79 |

colored plate 7#

| Observing | | | | | |
|---|---|---|---|---|---|
| angle | L* | a* | b* | C* | h° |
| 15° | 61.60 | −7.41 | −9.85 | 12.32 | 233.04 |
| 25° | 44.81 | −4.80 | −8.25 | 9.55 | 239.79 |
| 45° | 24.06 | 0.26 | −3.90 | 3.91 | 273.75 |
| 75° | 14.76 | 5.28 | 1.60 | 5.52 | 16.86 |
| 110° | 11.23 | 6.73 | 3.77 | 7.72 | 29.26 |

colored plate 8#

| Observing | | | | | |
|---|---|---|---|---|---|
| angle | L* | a* | b* | C* | h° |
| 15° | 56.72 | −4.93 | −7.85 | 9.27 | 237.85 |
| 25° | 42.51 | −3.56 | −6.96 | 7.82 | 242.90 |
| 45° | 22.49 | −0.57 | −4.14 | 4.18 | 262.10 |
| 75° | 11.41 | 3.01 | 0.13 | 3.01 | 2.50 |
| 110° | 7.44 | 4.14 | 1.87 | 4.54 | 24.34 |

colored plate 9#

| Observing | | | | | |
|---|---|---|---|---|---|
| angle | L* | a* | b* | C* | h° |
| 15° | 56.07 | −7.33 | −8.13 | 10.94 | 227.96 |
| 25° | 41.95 | −4.86 | −7.08 | 8.59 | 235.50 |
| 45° | 22.57 | −0.56 | −4.05 | 4.09 | 262.10 |
| 75° | 12.67 | 4.50 | −0.15 | 4.50 | 358.03 |
| 110° | 8.95 | 6.58 | 1.19 | 6.69 | 10.27 |

colored plate 10#

| Observing | | | | | |
|---|---|---|---|---|---|
| angle | L* | a* | b* | C* | h° |
| 15° | 56.00 | −8.56 | −7.94 | 11.67 | 222.86 |
| 25° | 41.96 | −5.73 | −6.81 | 8.90 | 229.94 |
| 45° | 22.81 | −0.53 | −3.51 | 3.55 | 261.39 |
| 75° | 13.19 | 5.14 | 0.80 | 5.21 | 8.82 |
| 110° | 9.60 | 7.28 | 2.34 | 7.65 | 17.81 |

colored plate 11#

| Observing | | | | | |
|---|---|---|---|---|---|
| angle | L* | a* | b* | C* | h° |
| 15° | 56.85 | −7.93 | −8.57 | 11.67 | 227.20 |
| 25° | 42.58 | −5.39 | −7.39 | 9.15 | 233.90 |
| 45° | 22.84 | −0.90 | −4.10 | 4.20 | 257.68 |
| 75° | 12.65 | 4.37 | 0.11 | 4.37 | 1.45 |
| 110° | 8.87 | 6.51 | 1.63 | 6.71 | 14.03 |

colored plate 12#

| Observing | | | | | |
|---|---|---|---|---|---|
| angle | L* | a* | b* | C* | h° |
| 15° | 57.55 | −7.42 | −9.65 | 12.17 | 232.47 |
| 25° | 43.15 | −4.95 | −8.21 | 9.59 | 238.93 |
| 45° | 23.12 | −0.57 | −4.32 | 4.36 | 262.43 |
| 75° | 12.70 | 4.69 | 0.58 | 4.73 | 7.02 |
| 110° | 8.87 | 6.89 | 2.35 | 7.28 | 18.81 |

colored plate 13#

| Observing | | | | | |
|---|---|---|---|---|---|
| angle | L* | a* | b* | C* | h° |
| 15° | 56.58 | −7.41 | −8.63 | 11.37 | 229.34 |
| 25° | 42.36 | −4.87 | −7.47 | 8.91 | 236.91 |
| 45° | 22.73 | −0.32 | −4.24 | 4.25 | 265.73 |
| 75° | 12.63 | 5.09 | −0.15 | 5.09 | 358.36 |
| 110° | 8.87 | 7.32 | 1.28 | 7.43 | 9.90 |

colored plate 14#

| Observing | | | | | |
|---|---|---|---|---|---|
| angle | L* | a* | b* | C* | h° |
| 15° | 57.31 | −7.33 | −8.79 | 11.44 | 230.15 |
| 25° | 42.94 | −4.90 | −7.53 | 8.98 | 236.97 |
| 45° | 22.97 | −0.58 | −4.04 | 4.08 | 261.83 |
| 75° | 12.58 | 4.64 | 0.51 | 4.67 | 6.28 |
| 110° | 8.74 | 6.84 | 2.18 | 7.18 | 17.64 |

colored plate 15#

| Observing | | | | | |
|---|---|---|---|---|---|
| angle | L* | a* | b* | C* | h° |
| 15° | 55.18 | −5.98 | −9.43 | 11.16 | 237.63 |
| 25° | 41.53 | −3.79 | −8.14 | 8.98 | 245.02 |
| 45° | 22.48 | −0.32 | −4.25 | 4.27 | 265.72 |
| 75° | 12.56 | 4.02 | 0.73 | 4.09 | 10.25 |
| 110° | 8.69 | 6.01 | 2.61 | 6.55 | 23.45 |

colored plate 16#

| Observing | | | | | |
|---|---|---|---|---|---|
| angle | L* | a* | b* | C* | h° |
| 15° | 55.10 | −7.55 | −8.76 | 11.56 | 229.24 |
| 25° | 42.16 | −4.97 | −7.76 | 9.22 | 237.37 |
| 45° | 23.35 | −0.79 | −4.19 | 4.26 | 259.32 |
| 75° | 13.18 | 4.05 | 0.60 | 4.09 | 8.44 |
| 110° | 9.05 | 6.23 | 2.64 | 6.77 | 22.93 |

### Example 17

To test the influence of a clearcoat, colored plate 1-C# was prepared by a process comprising steps of:
(1) applying a primer on a substrate plate, then drying the primer at room temperature for 5 min, to form a primer film having a thickness of 12 μm on the substrate plate; and
(2) applying the coating composition 1 in table 1 on the primer film, then drying the coating composition at room temperature for 5 min and then at 80° C. for 5 min, to form a coating film having a thickness of 12 μm, thus obtaining colored plate 1-C#.

The measured CIELAB and CIEHLC color space of colored plate 1-C# and colored plate 1# prepared in example 1 were compared as follows:

colored plate 1-C#

| Observing | | | | | |
|---|---|---|---|---|---|
| angle | L* | a* | b* | C* | h° |
| 15° | 62.96 | −8.35 | −10.24 | 13.19 | 231.7 |
| 25° | 42.65 | −4.97 | −8.16 | 9.54 | 239.63 |
| 45° | 21.38 | 0.71 | −3.67 | 4.85 | 272.08 |
| 75° | 13.37 | 5.22 | 0.91 | 5.31 | 6.95 |
| 110° | 10.41 | 6.29 | 2.28 | 6.62 | 20.31 |

The measured CIELAB and CIEHLC color space of colored plate 1 # were provided as follows.

colored plate 1#

| Observing | | | | | |
|---|---|---|---|---|---|
| angle | L* | a* | b* | C* | h° |
| 15° | 57.70 | −7.86 | −9.66 | 12.45 | 230.85 |
| 25° | 41.71 | −5.04 | −7.96 | 9.44 | 237.75 |
| 45° | 22.00 | −0.01 | −4.05 | 4.05 | 269.81 |
| 75° | 13.35 | 4.65 | 0.65 | 4.70 | 7.90 |
| 110° | 10.11 | 5.99 | 2.35 | 6.44 | 21.45 |

It can be seen that the CIELAB and CIEHLC color space of the obtained colored plates I and II keep substantially the same to each other whether there is a clearcoat layer or not.

1. A metallic effect coating composition comprising
(A) a pigment composition comprising:
(A-1) a yellowish red pigment;
(A-2) a magenta pigment; and
(A-3) a greenish blue pigment,
(B) a binder;
(C) carbon black; and
(D) aluminum, wherein the sum of weight percentages of components (A-1), (A-2) and (A-3) is at least 80% by weight based on the total weight of component (A).

2. The coating composition according to claim 1, wherein said component (A) comprises
from 20% to 60%, by weight of component (A-1),
from 10% to 40% by weight of component (A-2), and
from 20% to 50% by weight of component (A-3), based on the total weight of component (A).

3. The coating composition according to claim 1, wherein
said component (A-1) is one selected from the group consisting of C.I. Pigment Red 101 and C.I. Pigment Red 254,
said component (A-2) is one selected from the group consisting of C.I. Pigment Red 122, C.I. Pigment Red 202, C.I. Pigment Violet 19 and a mixture of C.I. Pigment Red 177 and C.I. Pigment Violet 23, in a ratio by weight of from 1:10 to 10:1, and
said component (A-3) is one selected from the group consisting of C.I. Pigment Blue 15, a mixture of C.I. Pigment Blue 15 and C.I. Pigment Green 7, in a ratio by weight of from 1:2 to 2:1, and a mixture of C.I. Pigment Blue 15 and C.I. Pigment Green 36, in a ratio by weight of from 1:1 to 25:1.

4. The coating composition according to claim 1, wherein the coating composition comprises from 0.3% to 3% by weight of component (A), based on the total weight of the coating composition.

5. The coating composition according to claim 1, wherein said binder is at least three selected from the group consisting of polyester, polyurethane, poly(meth)acrylates, cellulose acetate butyrate resin and melamine resin.

6. The coating composition according to claim 1, wherein the coating composition comprises
from 10% to 30% by weight of component (B);
from 0.05% to 0.3% by weight of component (C); and
from 0.5% to 2.0% by weight of component (D), based on the total weight of the coating composition.

7. The coating composition according to claim 1, wherein the coating composition further comprises from 20% to 70%, by weight of water, based on the total weight of the coating composition.

8. The coating composition according to claim 1, further comprising from 10% to 30% by weight of solvent, based on the total weight of the coating composition.

9. The coating composition according to claim 1, wherein the coating composition further comprises at least three additive selected from the group consisting of antifoaming agents, ultraviolet absorbers, rheology control agents, antioxidants, surface conditioners, dispersing agents, anti-settling agents, and pH adjusting agents, wherein the amount of said additive(s) is no more than 10% by weight based on the total weight of the coating composition.

10. The coating composition according to claim 1, wherein the coating composition has a pH value in a range of from 7.5 to 8.5.

11. The coating composition according to claim 1, wherein the coating composition is capable of forming a coating film having CIELAB color space with L*, a*, b* values as defined in at least three of conditions I, II, III, IV and V:

| | Observing | | | |
|---|---|---|---|---|
| Condition | angle | L* | a* | b* |
| I | 15° | from 47 to 67 | from −11 to 5 | from −13 to 7 |
| II | 25° | from 30 to 50 | from −8 to 2 | from −11 to 5 |
| III | 45° | from 12 to 32 | from −3 to 3 | from −7 to 1 |
| IV | 75° | from 4 to 24 | from 2 to 8 | from −2 to 4 |
| V | 110° | from 0 to 20 | from 3 to 9 | from −1 to 5. |

12. The coating composition according to claim 1, wherein the coating composition is capable of forming a coating film having CIEHLC color space with C*, h° values as defined in at least three of conditions VI, VII, VIII, IX and X:

| Condition | Observing angle | C* | h° |
|---|---|---|---|
| VI | 15° | from 9 to 15 | from 210 to 250 |
| VII | 25° | from 6 to 12 | from 220 to 260 |
| VIII | 45° | from 1 to 7 | from 250 to 290 |
| IX | 75° | from 2 to 8 | 0 to 20 |
| X | 110° | from 3 to 9 | from 8 to 30. |

13. A coating film obtained from the coating composition according to claim 1, wherein the CIELAB color space of said coating film has L*, a*, b* values as defined in at least three of conditions I, II, III, IV and V:

| | Observing | | | |
|---|---|---|---|---|
| Condition | angle | L* | a* | b* |
| I | 15° | from 47 to 67 | from −11 to 5 | from −13 to 7 |
| II | 25° | from 30 to 50 | from −8 to 2 | from −11 to 5 |
| III | 45° | from 12 to 32 | from −3 to 3 | from −7 to 1 |
| IV | 75° | from 4 to 24 | from 2 to 8 | from −2 to 4 |
| V | 110° | from 0 to 20 | from 3 to 9 | from −1 to 5. |

14. The coating film obtained from the coating composition according to claim 1, condition wherein the CIEHLC color space of said coating film has C*, h° values as defined in at least three of conditions VI, VII, VIII, IX and X:

| Condition | Observing angle | C* | h° |
|---|---|---|---|
| VI | 15° | from 9 to 15 | from 210 to 250 |
| VII | 25° | from 6 to 12 | from 220 to 260 |
| VIII | 45° | from 1 to 7 | from 250 to 290 |
| IX | 75° | from 2 to 8 | from 0 to 20 |
| X | 110° | from 3 to 9 | from 8 to 30. |

15. The coating composition according to claim 1, wherein the sum of weight percentages of components (A-1), (A-2) and (A-3) is at least 95% by weight based on the total weight of component (A).

16. The coating composition according to claim 1, wherein the sum of weight percentages of components (A-1), (A-2) and (A-3) is 100% by weight based on the total weight of component (A).

17. The coating composition according to claim 1, wherein said component (A) comprises
from 40% to 60% by weight of component (A-1),
from 10% to 20% by weight of component (A-2), and
from 20% to 40% by weight of component (A-3),
based on the total weight of component (A).

18. The coating composition according to claim 1, wherein said component (A-3) is selected from the group consisting of a mixture of C.I. Pigment Blue 15 and C.I. Pigment Green 7 and a mixture of C.I. Pigment Blue 15 and C.I. Pigment Green 36.

19. The coating composition according to claim 1, wherein the coating composition comprises from 0.5% to 2% by weight of component (A), based on the total weight of the coating composition.

20. The coating composition according to claim 1, wherein the coating composition comprises
from 12% to 20% by weight of component (B;
from 0.05% to 0.2% by weight of component (C); and
from 0.8% to 1.8% by weight of component (D), based on the total weight of the coating composition.
